(19) United States
(12) Patent Application Publication
(10) Pub. No.: US 2024/0275443 A1
(43) Pub. Date: Aug. 15, 2024

(54) METHODS FOR RATE IMPROVEMENT WITH INDEPENDENT SYMBOL PROCESSING OF BEAMFORMED SIGNALS

(71) Applicant: QUALCOMM Incorporated, San Diego, CA (US)

(72) Inventors: Vasanthan RAGHAVAN, West Windsor Township, NJ (US); Juergen CEZANNE, Ocean Township, NJ (US); Junyi LI, Fairless Hills, PA (US)

(21) Appl. No.: 18/169,816

(22) Filed: Feb. 15, 2023

(51) Int. Cl. H04B 7/06; H04B 7/0456

(52) U.S. Cl. CPC H04B 7/0617; H04B 7/0456

(57) ABSTRACT

A method for wireless communication at a user equipment (UE) and related apparatus are provided. In the method, the UE receives multiple transmissions from a network entity. Each transmission of the multiple transmissions may use one symbol of a set of multiple symbols and may be sent using one transmit beam of multiple transmit beams. The UE further determines a first linear combination of the multiple transmissions that emulates an adaptive transmit beam weight, and determines an adaptive receive beam weight based on a second linear combination of multiple receive beams. The method enables a UE to emulate the adaptive transmitting weight based on a linear combination of multiple transmissions of independent symbols, and to adjust the receive beams based on the linear combination. It improves signal reception and efficiency of wireless communication.

### TECHNICAL FIELD

The present disclosure relates generally to communication systems, and more particularly, to wireless communication with beamformed signals.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include memory and at least one processor coupled to the memory. Based at least in part on information stored in the memory, the at least one processor may be configured to receive multiple transmissions from a network entity, where each transmission of the multiple transmissions uses one symbol of a set of multiple symbols and is sent using one transmit beam of multiple transmit beams; and determine a first linear combination of the multiple transmissions, wherein the first linear combination emulates an adaptive transmit beam weight for the network entity.

In an aspect of the disclosure, a method, a computer-readable medium, and an apparatus are provided for wireless communication at a network entity. The apparatus may include memory and at least one processor coupled to the memory. Based at least in part on information stored in the memory, the at least one processor may be configured to transmit multiple transmissions to a UE, where each transmission of the multiple transmissions uses one symbol of a set of multiple symbols and is sent using one transmit beam of multiple transmit beams, the multiple transmissions cause the UE to determine a first linear combination of the multiple transmissions, and where the first linear combination emulates an adaptive transmit beam weight for the network entity; and communicate with the UE based on the first linear combination of the multiple transmissions.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example beam management.

FIG. 4B is a diagram illustrating an example inter-cell beam management.

FIG. 5 is a diagram illustrating an example method of independent symbol processing of beamformed signals, in accordance with various aspects of the present disclosure.

FIG. 6 is a call flow diagram illustrating a method of wireless communication in accordance with various aspects of the present disclosure.

FIG. 7 is the first flowchart illustrating methods of wireless communication at a UE in accordance with various aspects of the present disclosure.

FIG. 8 is the second flowchart illustrating methods of wireless communication at a UE in accordance with various aspects of the present disclosure.

FIG. 9 is the first flowchart illustrating methods of wireless communication at a network entity in accordance with various aspects of the present disclosure.

FIG. 10 is the second flowchart illustrating methods of wireless communication at a network entity in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

A network may be in communication with a UE based on one or more beams (spatial filters). For example, a base station of the network may transmit a beamformed signal to a UE in one or more directions that correspond with one or more beams, which can also be referred to as a beam direction or a directional beam. The base station and the UE may perform beam training to determine the best receive beam direction and transmit beam direction for wireless communication between the base station and the UE.

Various aspects presented herein relate generally to independent symbol processing of beamformed signals. Some aspects more specifically relate to a receiver, such as a UE, determining and using linear combination weights for processing received beamformed signals over independent times, such as over independent symbols, to emulate an adaptive beam weight from the transmitter, such as a base station or network node.

Aspects of the subject matter described in this disclosure can be implemented to realize one or more of the following potential advantages. In some examples, by performing the independent symbol processor on beamformed signals and using linear combination weights to emulate an adaptive beam weight, the receiver improves performance gains with reduced feedback overhead, e.g., without the added configuration of reference signals for measurement and resources for reports of measurements.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Various aspects relate generally to communication systems. Some aspects more specifically relate to wireless communication with independent symbol processing of beamformed signals for rate improvement. In some examples, a UE may receive multiple transmissions from a network entity. Each transmission of the multiple transmissions may use one symbol of a set of multiple symbols and may be sent using one transmit beam of multiple transmit beams. The UE may further determine a first linear combination of the multiple transmissions. The first linear combination may emulate an adaptive transmit beam weight for the network entity. In some aspects, the UE may adjust the adaptive receive beam weight on the UE side according to the first linear combination to obtain the adjusted receive beam weight.

Particular aspects of the subject matter described in this disclosure can be implemented to realize one or more of the following potential advantages. In some examples, by receiving multiple transmissions from a network entity, with each transmission of the multiple transmissions using one symbol of a set of multiple symbols and being sent using one transmit beam of multiple transmit beams, and using a first linear combination of the multiple transmissions to emulate an adaptive transmit beam weight for the network entity, the described techniques can be used to enable a UE to emulate the adaptive transmitting weight based on a linear combination of multiple transmissions of independent symbols. The UE may further adjust the receive beams based on the linear combination. Hence, the method improves signal reception and efficiency of wireless communication.

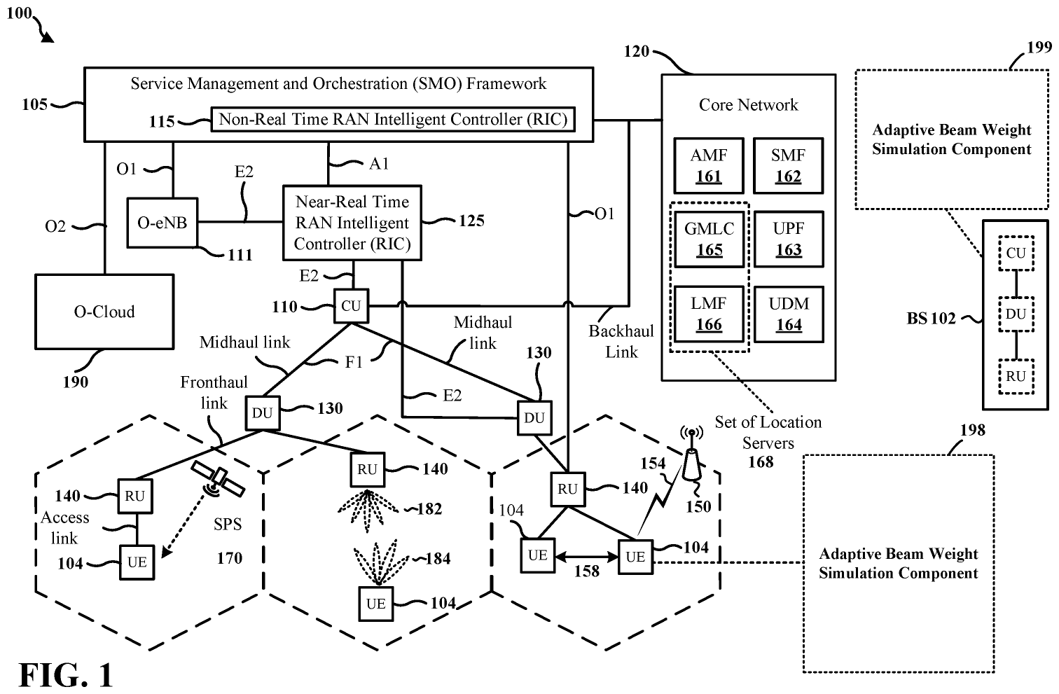

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an El interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an Al interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as Al policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an Adaptive Beam Weight Simulation component 198. The Adaptive Beam Weight Simulation component 198 may be configured to receive multiple transmissions from a network entity. Each transmission of the multiple transmissions may use one symbol of a set of multiple symbols and may be sent using one transmit beam of multiple transmit beams. The Adaptive Beam Weight Simulation component 198 may be further configured to determine a first linear combination of the multiple transmissions, where the first linear combination emulates an adaptive transmit beam weight of the network entity. In certain aspects, the base station 102 may include an Adaptive Beam Weight Simulation component 199. The Adaptive Beam Weight Simulation component 199 may be configured to transmit multiple transmissions to a UE. Each transmission of the multiple transmissions may use one symbol of a set of multiple symbols and may be sent using one transmit beam of multiple transmit beams. The multiple transmissions may cause the UE to determine a first linear combination of the multiple transmissions. The first linear combination may emulate an adaptive transmit beam weight of the network entity. The Adaptive Beam Weight Simulation component 199 may be further configured to communicate with the UE based on the first linear combination of the multiple transmissions. Although the following description may be focused on 5G NR, the concepts described herein may be applicable to other similar areas, such as LTE, LTE-A, CDMA, GSM, and other wireless technologies.

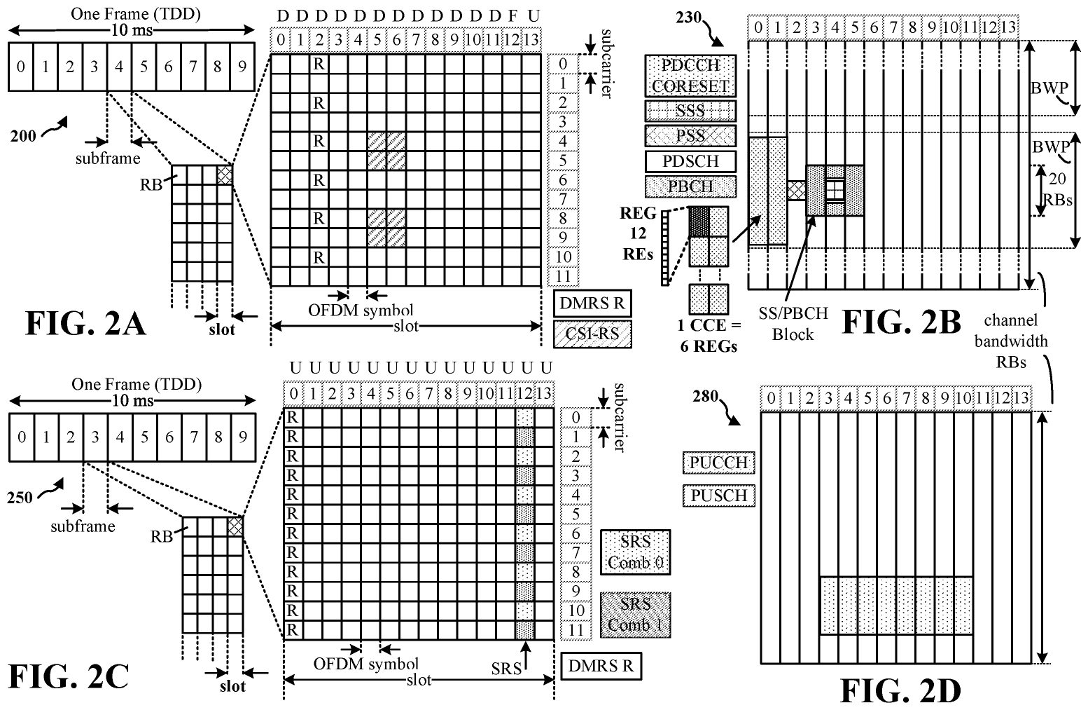

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies u 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

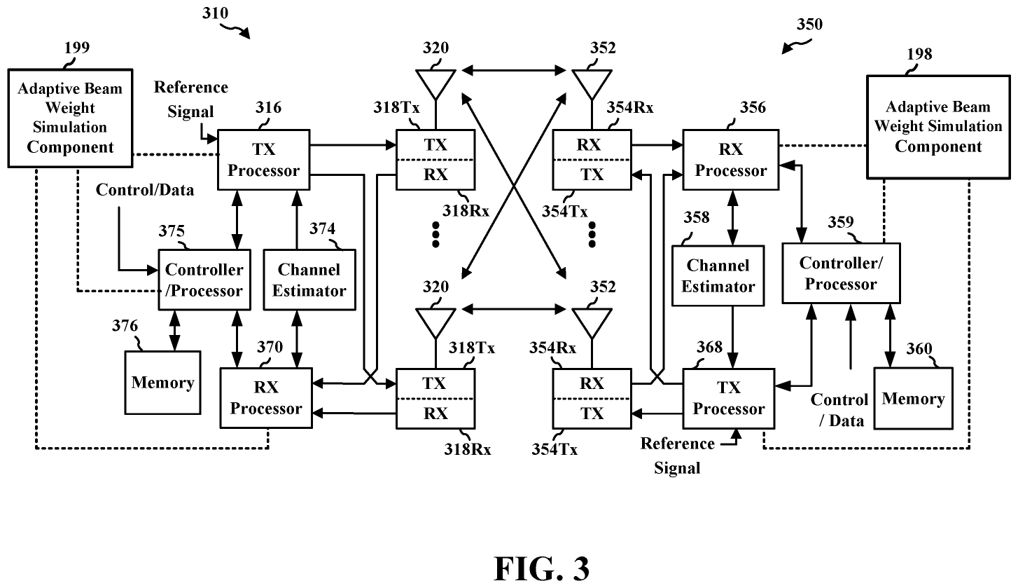

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the Adaptive Beam Weight Simulation component 198 of FIG. 1.

At least one of the TX processor 316, the RX processor 370, and the controller/processor 375 may be configured to perform aspects in connection with the Adaptive Beam Weight Simulation component 199 of FIG. 1.

A network may be in communication with a UE based on one or more beams (spatial filters). For example, a base station of the network may transmit a beamformed signal to a UE in one or more directions that correspond with one or more beams, which can also be referred to as a beam direction or a directional beam. The base station and the UE may perform beam training to determine the best receive beam direction and transmit beam direction (e.g., 182 and 184 in FIG. 1) for wireless communication between the base station and the UE.

In response to different conditions, beams may be switched. For example, a TCI state change may be transmitted by a base station so that the UE may switch to a new beam for the TCI state. The TCI state change may cause the UE to find the best UE receive beam corresponding to the TCI state from the base station and switch to such beam. Switching beams may allow for enhanced or improved connection between the UE and the base station by ensuring that the transmitter and receiver use the same configured set of beams for communication. A TCI state may include quasi co-location (QCL) information that the UE can use to derive timing/frequency error and/or transmission/reception spatial filtering for transmitting/receiving a signal.

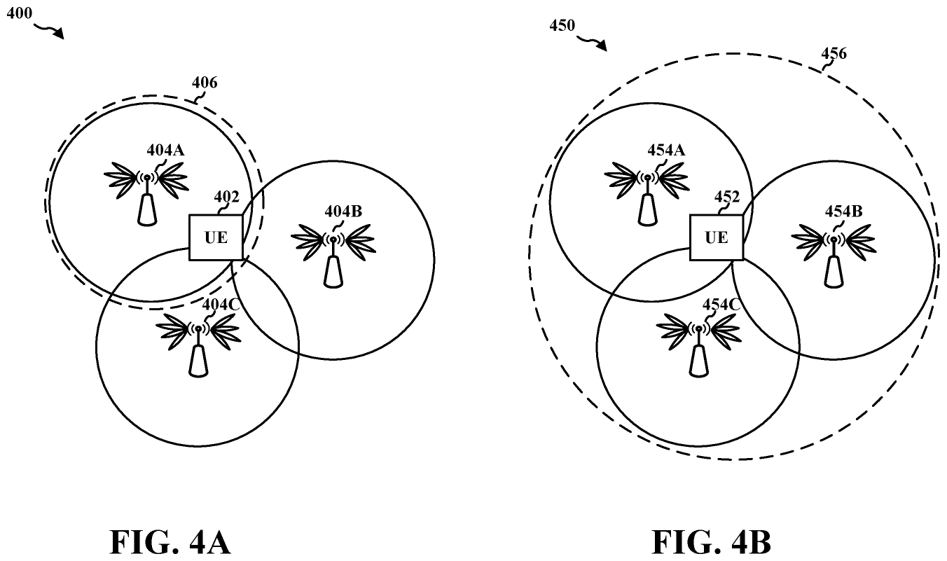

Different procedures for managing and controlling beams may be collectively referred to as “beam management.” The process of selecting a beam to switch to for data channels or control channels may be referred to as “beam selection.” In some wireless communication systems, beam selection for data channels or control channels may be limited to beams within the same physical cell identifier (ID) (PCI). A PCI may be associated with a TRP. FIG. 4A is a diagram 400 illustrating an example of beam management. As illustrated in FIG. 4A, for a UE 402, beam selection 406 may be limited to beams within the PCI 404A and beams associated with the PCI 404B and the PCI 404C may not be used. As an example, each of the PCI 404A, the PCI 404B, and the PCI 404C may be associated with a different TRP. In other aspects, the UE may select beams among multiple cells.

In some wireless communication systems, inter-cell beam management may be based on beam-based mobility where the indicated beam may be from a TRP with different PCI with regard to the serving cell. Benefits of inter-cell beam management based on beam-based mobility may include more robustness against blocking, more opportunities for higher rank for subscriber data management (SDM) across different cells, and in general, more efficient communication between a UE and the network. FIG. 4B is a diagram 450 illustrating an example of inter-cell beam management. As illustrated in FIG. 4B, for a UE 452, beam selection 456 may be based on beams within the PCI 454A and beams associated with the PCI 454B and the PCI 454C. As an example, each of the PCI 454A, the PCI 454B, and the PCI 454C may be associated with a different TRP.

Beamforming has an effect on rate improvement in wireless communication systems, such as for wireless communication in the FR2 frequency range and beyond. Beamforming schemes may take advantage of a small number of clusters in a channel and steer energy towards the more dominant cluster(s) in the channel. Therefore, such schemes are directional in nature.

In some deployments (e.g., indoor office settings, shopping mall, downtown, stadium use cases, etc.), there may be multiple dominant clusters in the channel. The energy across multiple clusters (with a given angular spread) may be combined using adaptive beam weights. The adaptive beam weights do not constrain the beam weight structure to that of directional beam weights, and the adaptive beam weights may provide an optimization over the space of phase shifters and/or amplitude control. The adaptive beam weights may approximate the performance of the dominant right/left-singular vectors of the channel and may lead to performance improvements.

The adaptive beam weight may be used at one side of the transmission (e.g., the UE side) or one end of a communication link between two wireless devices. As an example, one device may employ adaptive beam weights without the other device being aware of the adaptive beam weights. Additional performance gains may be realized if both devices implement adaptive beam weights. For example, performance gains may be improved if a base station and a UE both use adaptive beam weights that approximate the right-singular vector and left-singular vector structures for optimal beamformers, respectively. Implementing adaptive beam weights on both sides of the link (e.g., the UE side and the network side or on the transmitter side and the receiver side), includes coordination in terms of beam weight design and feedback of signal strengths over RSs. The number of RSs may grow significantly with the antenna dimensions. Additionally, the adaptive beam weight on the network side may vary across different base station deployments and implementation may be challenging from a network-level perspective.

The present disclosure provides methods and apparatus for rate improvement with independent symbol processing of beamformed signals. In some aspects, the methods may include the processing of an adaptive beam weight at one side of a communication link (e.g., the UE side) over multiple independent times/symbols to emulate the adaptive beam weight at the other side of the link (e.g., the network side). The methods involve some feedback overhead and with this cost, may significantly improve the performance as channel conditions become favorable.

In some aspects, an Nᵣ×Nₜ downlink channel matrix H between a UE and a base station, where Nᵣ represents antenna elements at the UE and Nₜ represents antenna elements at the base station, may correspond to L clusters, and the downlink channel matrix H may be described as:

$$H = {Σ}_{ℓ = 1}^{L} {α}_{ℓ} \cdot {u}_{ℓ} {v}_{ℓ} \qquad ( 1 )$$

where μₗ is the array steering vector at the UE side, and [symbol]
is the array steering vector at the network side, and [symbol]
is the complex gain corresponding to the l-th cluster.

The beamforming vectors at the network side (f) and the UE side (g) that maximize the received SNR may be determined based on:

$$\hat{s} = {g}^{H} \cdot ( Hfs + n ) \qquad ( 2 )$$

$$SNR = {\vert {g}^{H} Hf \vert}^{2} \qquad ( 3 )$$

where s is the signal to be transmitted, and n represents the additive noise in the reception.

In a directional beamforming setting, the beamforming vectors f and g may be chosen from the codebooks of beams

[symbol]

and [symbol] , respectively. The codebooks of beams [symbol]
and [symbol]
may have sizes N and M, respectively, and may be described as:

$$= \{ {f}_{1} , {f}_{2} , … , {f}_{N} \} \qquad ( 4 )$$

$$= \{ {g}_{1} , {g}_{2} , … , {g}_{M} \} \qquad ( 5 )$$

The optimal beamforming vectors fₒₚₜ and gₒₚₜ that maximize the SNR may correspond to the dominant right-singular vector and the dominant left-singular vector of channel H, respectively. The optimal beamforming vectors fₒₚₜ and gₒₚₜ correspond to a linear combination of the array steering vectors { vₗ} and {uₗ}, respectively. The direction-based selection of the array steering vectors may be subject to the size and granularity of the codebooks. The codebook based performance may deteriorate in a channel where the number of clusters L is large and the gains corresponding to these L clusters are comparable.

In the methods of the present disclosure, an adaptive/dynamic beam weight may be learned at both the network side and the UE side, and quantized dominant right-singular vector and dominant left-singular vector of the channel improve the performance of the direction-based methods. In this disclosure, the “beam weight” may refer to a weight (including a phase shifting state and a gain/amplitude state) that is used to weigh the signal over each antenna element. An “adaptive beam weight” refers to a beam weight beyond those stored in memory for directionally steered beams. For ease of description, as used herein, a “beam weight” or “adaptive beam weight” may, in some examples, refer to a set of beam weights (or adaptive beam weights) corresponding to multiple beams, respectively.

The construction of the adaptive/dynamic beam weights at the UE side may include a search over phase shifter and/or amplitude control possibilities. Hence, if enough resources are available, such learning may be realized at a UE. On the other hand, the construction of the adaptive/dynamic beam weight at the network side may involve feedback on the best few TCI states and a search over co-phasing factors for a linear combination of these TCI states. Such an approach may include the base station configuring aperiodic CSI-RS signals for a specific UE and requesting and receiving SINR/RSRP feedback for these CSI-RS signals. For the base station to determine the adaptive/dynamic beam weight as an optimization problem over the phase shifter and/or amplitude control space, the learning cost is likely to be proportional to antenna dimensions.

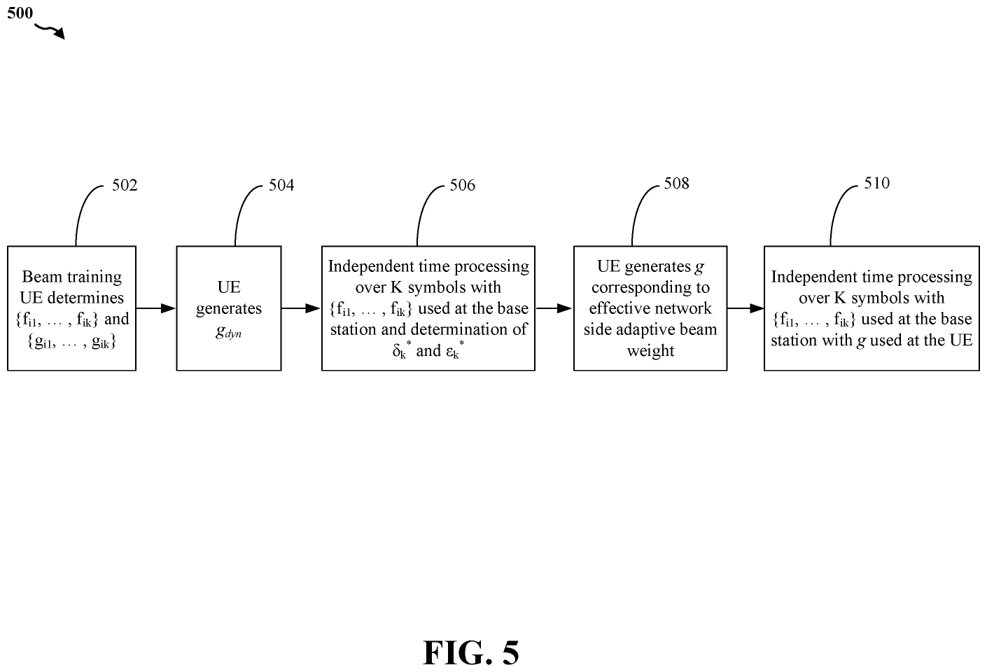

The present disclosure provides an independent symbol processing of beamformed signals that may be implemented at a UE. FIG. 5 is a diagram 500 illustrating an example method of independent symbol processing of beamformed signals, in accordance with various aspects of the present disclosure.

In some aspects, at 502, the UE and the base station may use a beam training scheme to learn the best set of K beams to be used at both the UE side and the network side. In one example, the existing beam training scheme may include the P1/P2/P3 procedures, which may include the base station sweeping transmit beams for the UE to select the best transmit beam among them and to report it to the base station, and the UE selecting a pairing receive beam from multiple receive beams under the selected transmit beam. K may be configured by the base station or the UE based on the channel environment. For example, the K beams on the network side may be {fᵢ_{₁}, . . . , fᵢ_{_{K}}}, and the K beams at the UE side may be {gᵢ_{₁}, . . . , gᵢ_{_{K}}}. The beams fᵢ_{ₖ} and gᵢ_{ₖ} may be the beams paired together at the UE side and the network side, respectively.

In some aspects, at 504, the UE may determine the adaptive/dynamic beam weight to be used at the UE side as a linear combination of:

$${g}_{d y n} = \frac{{Σ}_{k = 1}^{K} {β}_{k} {e}^{i γ k} \cdot {g}_{{i}_{k}}}{‖ {Σ}_{k = 1}^{K} {β}_{k} {e}^{i γ k} \cdot {g}_{{i}_{k}} ‖} \qquad ( 6 )$$

At 506, at different and independent symbols, the base station may transmit with beams fᵢ_{ₖ} (k=1, . . . , K), and the UE may receive with the adaptive/dynamic beam weight g_{dyn}. The signal received by the UE may be expressed as:

$${\hat{s}}_{k} = {g}_{d y n}^{H} \cdot ( {Hf}_{{i}_{k}} s + {n}_{k} ) \qquad ( 7 )$$

Then, the UE may determine the linear combination Σₖ₌₁^{K}δₖe^{iϵ}^{ₖ}·Ŝ_{K} that maximizes the SNR as follow:

$$SNR = {max}_{\{ {δ}_{k} \} , \{ {ϵ}_{k} \}} \frac{{\vert {Σ}_{k = 1}^{K} {δ}_{k} {e}^{i {ϵ}_{k}} \cdot {g}_{d y n}^{H} {Hf}_{{i}_{k}} \vert}^{2}}{{Σ}_{k = 1}^{K} {δ}_{k}^{2}} \qquad ( 8 )$$

The beam weights δₖ and ϵₖ that maximize the SNR may be assumed to be δₖ* and ϵₖ*, respectively. At 508, the UE may re-determine the adaptive/dynamic beam weight at the UE side that works best for the linear combination of the network side beam weight over K independent symbols. The re-determined beam weight may be g. At 510, the re-determined beam weight g may be used to perform independent time processing of the signals received over {fᵢ_{₁}, . . . , fᵢ_{_{K}}}, with δₖ* and ϵₖ* used for linear combining these beamformed signals.

The SNR that may be achieved after these processes may be:

$$SNR = \frac{1}{K} \cdot \frac{{\vert {Σ}_{k = 1}^{K} {δ}_{k}^{*} {e}^{i {ϵ}_{k}^{*}} \cdot {g}^{H} {Hf}_{{i}_{k}} \vert}^{2}}{{Σ}_{k = 1}^{K} {( {δ}_{k}^{*} )}^{2}} \qquad ( 9 )$$

Performing the independent symbol processing may adversely affect the SNR due to the multiple time resources spent for the same performance. On the other hand, by emulating an adaptive/dynamic beam weight, the energy across multiple independent clusters that make the channel may be coherently combined. Hence, the gain from coherent combining the multiple clusters may be more than the losses due to the time averaging process.

In one example, the SNR differences between the scheme of the present disclosure and a scheme of steering beams towards the Angle of Departure (AoD)/Angle of Arrival (AoA) of the dominant cluster (e.g., the directional steering scheme) may be compared for a set of channel realizations. In this example, Nₜ=16, and Nᵣ=4, 6, or 8 linear antenna elements with 120° coverage at both the network side and the UE side are assumed. The channel between the UE and the base station is assumed to have L=6 clusters with 20 rays/paths over a 25° angular spread. For the implementation of the scheme of the present disclosure, it is assumed that the base station uses 32 Discrete Fourier Transform (DFT) beams and the UE uses 9, 12, or 16 beams in the three Nᵣ (e.g., Nᵣ=4, 6, 8) cases, respectively, and the scenario of K=2 is considered. In this example, the SNR gains with the proposed scheme (over the codebook directional steering scheme) may provide more than 50%, 70%, and 80% of channel realizations for Nᵣ=4, 6, and 8, respectively.

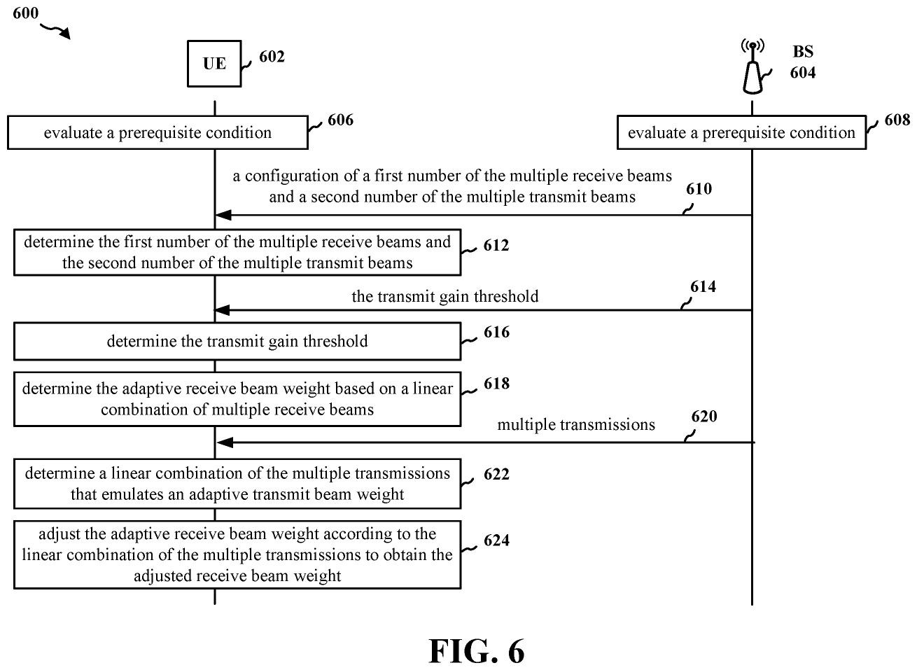

FIG. 6 is a call flow diagram 600 illustrating a method of wireless communication in accordance with various aspects of this present disclosure. Although aspects are described in connection with a base station 604, the aspects may be performed by a base station in aggregation and/or by one or more components of a base station 604 (e.g., such as a CU 110, a DU 130, and/or an RU 140).

As shown in FIG. 6, in some aspects, a UE 602 may, at 606, evaluate a condition associated with performing the adaptive beam weighting. The condition may be referred to as a prerequisite condition and may include one or more conditions or aspects. The UE may determine whether or not to perform independent symbol processing with adaptive beam weights based on an occurrence of one or more conditions. As an example, the prerequisite condition may be based on one or more of: the number of dominant clusters in the channel between the base station 604 and the UE 602, the angular spread associated with each of the dominant clusters, the transmitting antenna array dimension at the base station 604, the receiving antenna array dimension at the UE 602, the mobility condition between the base station 604 and the UE 602, and/or the rate parameter between the base station 604 and the UE 602. In some aspects, the UE 602 may perform the method of independent symbol processing of the present disclosure if the prerequisite condition meets a preset condition (e.g., the number of dominant clusters in the channel and/or the angular spread associated with each of the dominant clusters meet a preset criterion or threshold).

In some aspects, the prerequisite condition may be evaluated by the base station 604. For example, the base station 604 may evaluate the prerequisite condition at 608. In some aspects, the base station 604 may perform the method of independent symbol processing of the present disclosure if the prerequisite condition meets a preset condition.

In some aspects, at 610, the UE 602 may receive from the base station 604 a configuration of a first number of the multiple receive beams and a second number of the multiple transmit beams. For example, the base station 604 may use an existing beam training scheme (e.g., the P1/P2/P3 procedures) and identify the first number of multiple receive beams and the second number of multiple transmit beams for the UE 602 and the base station 604, respectively. For example, referring to FIG. 5, at 502, the first number of the multiple receive beams and the second number of the multiple transmit beams may be {gᵢ_{₁}, . . . , gᵢ_{_{K}}} and {fᵢ_{₁}, . . . , fᵢ_{_{K}}}, respectively.

In some aspects, at 612, the UE 602 may determine a first number of the multiple receive beams and a second number of the multiple transmit beams based on the channel condition of the channel between the base station and the UE. For example, the UE 602 may use an existing beam training scheme (e.g., the P1/P2/P3 procedures) to determine the first number of multiple receive beams and the second number of multiple transmit beams for the UE 602 and the base station 604, respectively. For example, referring to FIG. 5, at 502, the first number of the multiple receive beams and the second number of the multiple transmit beams may be {gᵢ_{₁}, . . . , gᵢ_{_{K}}} and {fᵢ_{₁}, . . . , fᵢ_{_{K}}}, respectively.

In some aspects, at 614, the UE 602 may receive from the base station 604 a transmit gain threshold. In some aspects, at 616, the UE 602 may determine the transmit gain threshold. The transmit gain threshold may be used to determine the linear combination of the multiple transmissions that emulates the adaptive beam weight at the network side. The linear combination weight may correspond to an amplitude and phase setting for weighting the beamformed signal. For example, the adaptive beam weight determined by the UE to emulate an adaptive beam weight to be used at the network side may approximate the dominant right-singular vector of the channel between the base station and the UE with a linear combination of steerable beams with gains above the transmit gain threshold (which may also be referred to as a signal strength threshold). The base station may determine beam weights from a beamforming codebook and use the codebook-based beam weights to transmit the multiple transmissions 620 to the UE 602. The transmit gain threshold may determine an approximation error in approximating the dominant right-singular vector of the channel. The signal strength threshold, or gain threshold may be configured for the UE by the base station or may be known or determined by the UE without a configuration from the base station.

At 618, the UE 602 may determine the adaptive receive beam weight based on a linear combination of multiple receive beams. For example, referring to FIG. 5, at 504, the UE may determine the adaptive receive beam weight g_{dyn} based on a linear combination of multiple receive beams through Equation (6).

At 620, the UE 602 may receive multiple transmissions from the base station 604. For example, referring to FIG. 5, at different and independent times, e.g., symbols, the UE may receive multiple transmissions with transmit beams fᵢ_{ₖ} (k=1, . . . , K) from the base station.

At 622, the UE 602 may determine a linear combination of the multiple transmissions that emulates an adaptive transmit beam weight. For example, referring to FIG. 5, at 506, the UE may determine the linear combination Σₖ₌₁^{K}δₖe^{iϵ}^{ₖ}·ŝₖ that maximizes the SNR as shown in Equation (8).

At 624, the UE 602 may adjust the adaptive receive beam weight according to the linear combination of the multiple transmissions to obtain adjusted receive beam weight. For example, referring to Equation (8), δₖ and ϵₖ that maximize the SNR may be assumed to be δₖ* and ϵₖ*. Referring to FIG. 5, at 508, the UE may adjust the adaptive receive beam weight according to the linear combination of the multiple transmissions to obtain adjusted receive beam weight (g). Thus, beamforming at the UE side may be performed with an adaptive beam weight that approximates the dominant left-singular vector of the channel between the base station and the UE with a linear combination of steerable beams determined from a directional beamforming codebook at the UE side.

The aspects of the present disclosure enable the UE to emulate an adaptive beam weighting approach by taking the symbols corresponding to different transmitted beam directions (which are different) and taking a linear combination of these post-processed symbols. The linear combination, at the UE, of different transmitted beam directions from the base station emulates an adaptive beam weight at the base station side. Once the UE determines how to take a linear combination of the different symbols from the base station (e.g., coming in different transmitted beam directions), the UE re-estimates a receive beam to match to this linear combination. The UE then uses the updated adaptive beam at the UE side to receive communication from the base station. The base station may communicate with the UE without being aware that the UE weighs these symbols with the linear combination. In some aspects, the UE and the base station may exchange signaling to switch from the approach described in FIG. 6, in which the UE emulates adaptive beam weights, to a non-adaptive beam weight scheme at the base station side.

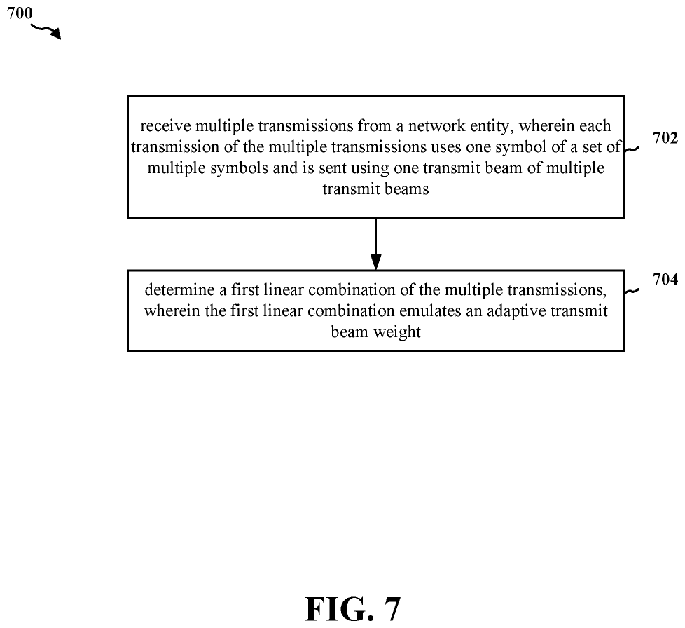

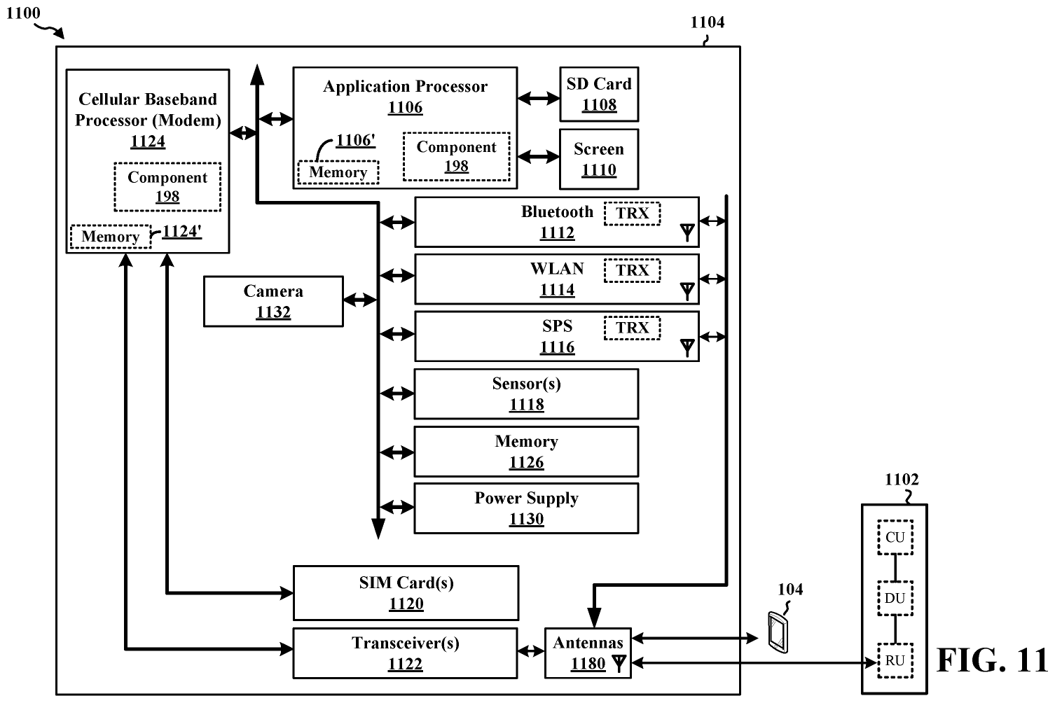

FIG. 7 is a flowchart 700 illustrating methods of wireless communication at a UE in accordance with various aspects of the present disclosure. The method may be performed by a UE. The UE may be the UE 104, 350, 602, or the apparatus 1104 in the hardware implementation of FIG. 11. The method enables a UE to emulate the adaptive transmitting weight based on a linear combination of multiple transmissions of independent symbols, and to adjust the receive beams based on the linear combination. The method improves signal reception and efficiency of wireless communication.

As shown in FIG. 7, at 702, the UE may receive multiple transmissions from a network entity. Each transmission of the multiple transmissions may use one symbol of a set of multiple symbols and may be sent using one transmit beam of multiple transmit beams. The network entity may be a base station, or a component of a base station, in the access network of FIG. 1 or a core network component (e.g., base station 102, 310, 604; or the network entity 1102 in the hardware implementation of FIG. 11). FIG. 6 illustrates various aspects of the steps in connection with flowchart 700. For example, referring to FIG. 6, the UE 602 may receive, at 620, multiple transmissions from a network entity (base station 604). Each transmission of the multiple transmissions may use one symbol of a set of multiple symbols and may be sent using one transmit beam of multiple transmit beams {fᵢ_{₁}, . . . , fᵢ_{_{K}}}.

At 704, the UE may determine a first linear combination of the multiple transmissions. The first linear combination of the multiple transmissions may emulate an adaptive transmit beam weight. For example, referring to FIG. 6, the UE 602 may determine, at 622, a linear combination of the multiple transmissions. The linear combination of the multiple transmissions may emulate an adaptive transmit beam weight.

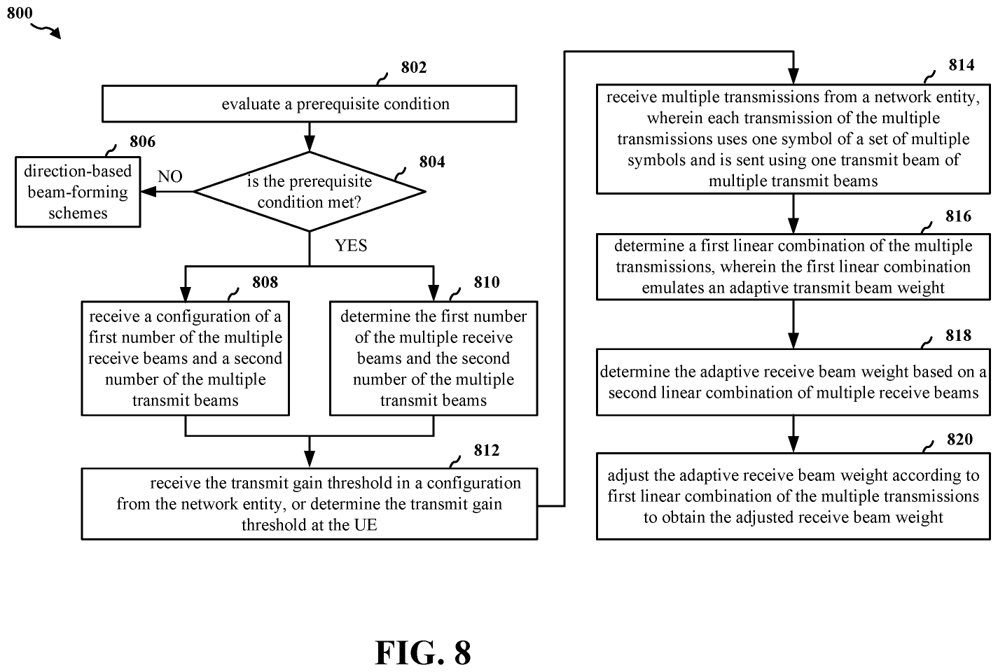

FIG. 8 is a flowchart 800 illustrating methods of wireless communication at a UE in accordance with various aspects of the present disclosure. The method may be performed by a UE. The UE may be the UE 104, 350, 602, or the apparatus 1104 in the hardware implementation of FIG. 11. The method enables a UE to emulate the adaptive transmitting weight based on a linear combination of multiple transmissions of independent symbols, and to adjust the receive beams based on the linear combination. The method improves signal reception and efficiency of wireless communication.

As shown in FIG. 8, at 814, the UE may receive multiple transmissions from a network entity. Each transmission of the multiple transmissions may use one symbol of a set of multiple symbols and may be sent using one transmit beam of multiple transmit beams. The network entity may be a base station, or a component of a base station, in the access network of FIG. 1 or a core network component (e.g., base station 102, 310, 604; or the network entity 1102 in the hardware implementation of FIG. 11). FIG. 6 illustrates various aspects of the steps in connection with flowchart 800. For example, referring to FIG. 6, the UE 602 may receive, at 620, multiple transmissions from a network entity (base station 604). Each transmission of the multiple transmissions may use one symbol of a set of multiple symbols and may be sent using one transmit beam of multiple transmit beams {fᵢ_{₁}, . . . , fᵢ_{_{K}}}.

At 816, the UE may determine a first linear combination of the multiple transmissions. The first linear combination of the multiple transmissions may emulate an adaptive transmit beam weight of the network entity. For example, referring to FIG. 6, the UE 602 may determine, at 622, a linear combination of the multiple transmissions. The linear combination of the multiple transmissions may emulate an adaptive transmit beam weight.

In some aspects, the multiple transmissions may be received by the UE using an adaptive receive beam weight of the UE. At 818, the UE may be configured to determine the adaptive receive beam weight based on a second linear combination of multiple receive beams. For example, referring to FIG. 5, at 504, the UE may generate an adaptive beam weight g_{dyn}, and the multiple transmissions may be received by the UE using the adaptive receive beam weight g_{dyn} according to Equation (7). The adaptive receive beam weight (g_{dyn}) may be determined based on a second linear combination of multiple receive beams {gᵢ_{₁}, . . . , gᵢ_{_{K}}} according to Equation (6).

In some aspects, the first linear combination may be determined based on the SNR associated with the multiple transmissions. For example, the first linear combination of the multiple transmissions may be determined to maximize the SNR, according to Equation (8).

In some aspects, the first linear combination may correspond to an amplitude and phase setting for weighting the multiple transmissions. For example, according to Equation (8), δₖ and ϵₖ that maximize the SNR may correspond to an amplitude (δₖ) and phase (ϵₖ) setting for weighting the multiple transmissions {fᵢ_{₁}, . . . , fᵢ_{_{K}}}.

In some aspects, the multiple transmit beams may be directionally steerable, and the adaptive transmit beam weight may approximate a dominant right-singular vector of the channel between the network entity and the UE with a linear combination of the multiple transmit beams with gains above a transmit gain threshold. For example, the multiple transmit beams {fᵢ_{₁}, . . . , fᵢ_{_{K}}} may be directionally steerable, and the adaptive transmit beam weight may approximate a dominant right-singular vector of the channel between the network entity and the UE with a linear combination of the multiple transmit beams {fᵢ_{₁}, . . . , fᵢ_{_{K}}} with gains above a transmit gain threshold.

In some aspects, the multiple transmit beams may be selected by the network entity from a network-side beamforming codebook. For example, the multiple transmit beams {fᵢ_{₁}, . . . , fᵢ_{_{K}}} may be selected by the network entity from a network-side beamforming codebook.

At 812, the UE may receive the transmit gain threshold in a configuration from the network entity or determine the transmit gain threshold at the UE. For example, referring to FIG. 6, the UE 602 may receive, at 616, the transmit gain threshold in a configuration from the network entity (base station 604) or determine the transmit gain threshold, at 618 at the UE 602.

At 820, the UE may adjust the adaptive receive beam weight according to the adaptive transmit beam weight to obtain the adjusted receive beam weight. For example, referring to FIG. 6, the UE 602 may adjust, at 624, the adaptive receive beam weight according to the first linear combination to obtain the adjusted receive beam weight (g). Referring to FIG. 5, at 508, the UE may adjust the adaptive receive beam weights according to the linear combination of the multiple transmissions {fᵢ_{₁}, . . . , fᵢ_{_{K}}} to obtain the adjusted receive beam weight (g).

In some aspects, the multiple receive beams may be directionally steerable, and the adjusted adaptive receive beam weight may approximate a dominant left-singular vector of a channel between the network entity and the UE with a linear combination of the multiple receive beams. For example, the multiple receive beams {gᵢ_{₁}, . . . , gᵢ_{_{K}}} may be directionally steerable, and the adjusted adaptive receive beam weight (g) may approximate a dominant left-singular vector of a channel between the network entity and the UE with a linear combination of the multiple receive beams {gᵢ_{₁}, . . . , ᵢ_{_{K}}}. In some aspects, the multiple receive beams may be selected by the UE from a UE-side beamforming codebook. For example, the multiple receive beams {gᵢ_{₁}, . . . , gᵢ_{_{K}}} may be selected by the UE from a UE-side beamforming codebook.

At 802, the UE may, prior to being configured to determine the first linear combination, evaluate a prerequisite condition. The UE may determine the first linear combination (at 816) in response to the prerequisite condition is determined, at 804, to be met. In some aspects, if the prerequisite condition is not met, the UE may use other beamforming schemes, such as a direction-based beam forming scheme (at 806). For example, referring to FIG. 6, the UE 602 may, prior to being configured to determine the first linear combination (at 622), evaluate a prerequisite condition at 606

In some aspects, the prerequisite condition may be based on one or more of: the number of dominant clusters in a channel between the network entity and the UE, the angular spread associated with each of the dominant clusters, the transmitting antenna array dimension at the network entity, the receiving antenna array dimension at the UE, the mobility condition between the network entity and the UE, and the rate requirement between the network entity and the UE. For example, referring to FIG. 6, when the UE 602 evaluates a prerequisite condition at 606, the prerequisite condition may be based on one or more of the number of dominant clusters in the channel between the network entity (base station 604) and the UE 602, the angular spread associated with each of the dominant clusters, the transmitting antenna array dimension at the network entity (base station 604), the receiving antenna array dimension at the UE 602, the mobility condition between the network entity (base station 604) and the UE 602, and the rate requirement between the network entity (base station 604) and the UE 602.

In some aspects, the multiple receive beams and the multiple transmit beams may be selected based on a beam training process. For example, referring to FIG. 5, at 502, the multiple receive beams {gᵢ_{₁}, . . . , gᵢ_{_{K}}} and the multiple transmit beams {fᵢ_{₁}, . . . , fᵢ_{_{K}}} may be selected based on a beam training process.

In some aspects, at 808, the UE may receive a configuration of a first number of the multiple receive beams and a second number of the multiple transmit beams. For example, referring to FIG. 6, the UE 602 may receive, at 610, a configuration of a first number of the multiple receive beams and a second number of the multiple transmit beams.

In some aspects, at 810, the UE may determine the first number of the multiple receive beams and the second number of the multiple transmit beams based on the channel condition of the channel between the network entity and the UE. For example, referring to FIG. 6, the UE 602 may determine, at 612, the first number of the multiple receive beams and the second number of the multiple transmit beams based on the channel condition of the channel between the network entity (base station 604) and the UE 602.

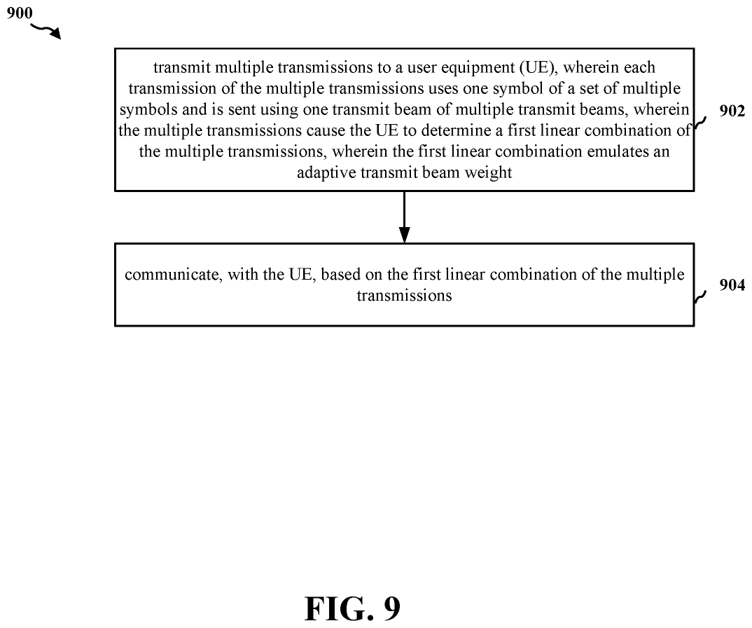

FIG. 9 is a flowchart 900 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 604; or the network entity 1102 in the hardware implementation of FIG. 11). The method enables a UE to emulate the adaptive transmitting weight based on a linear combination of multiple transmissions of independent symbols, and to adjust the receive beams based on the linear combination. The method improves signal reception and efficiency of wireless communication.

As shown in FIG. 9, at 902, the network entity may transmit multiple transmissions to a UE. Each transmission of the multiple transmissions may use one symbol of a set of multiple symbols and may be sent using one transmit beam of multiple transmit beams. The multiple transmissions may cause the UE to determine a first linear combination of the multiple transmissions, and the first linear combination may emulate an adaptive transmit beam weight of the network entity. The UE may be the UE 104, 350, 602, or the apparatus 1104 in the hardware implementation of FIG. 11. FIG. 6 illustrates various aspects of the steps in connection with flowchart 900. For example, referring to FIG. 6, the network entity (base station 604) may transmit, at 620, multiple transmissions to a UE 602. Each transmission of the multiple transmissions may use one symbol of a set of multiple symbols and may be sent using one transmit beam of multiple transmit beams {fᵢ_{₁}, . . . , fᵢ_{_{K}}}. The multiple transmissions may cause the UE to determine a first linear combination of the multiple transmissions (at 622), and the first linear combination may emulate an adaptive transmit beam weight of the network entity (base station 604).

At 904, the network entity may communicate with the UE based on the first linear combination. For example, referring to FIG. 5, at 508, the UE may generate the adjusted receive beam weight g corresponding to effective network side adaptive beam weight, which is based on the first linear combination of the multiple transmissions. At 510, the network entity may communicate with the UE based the adjusted receive beam weight g.

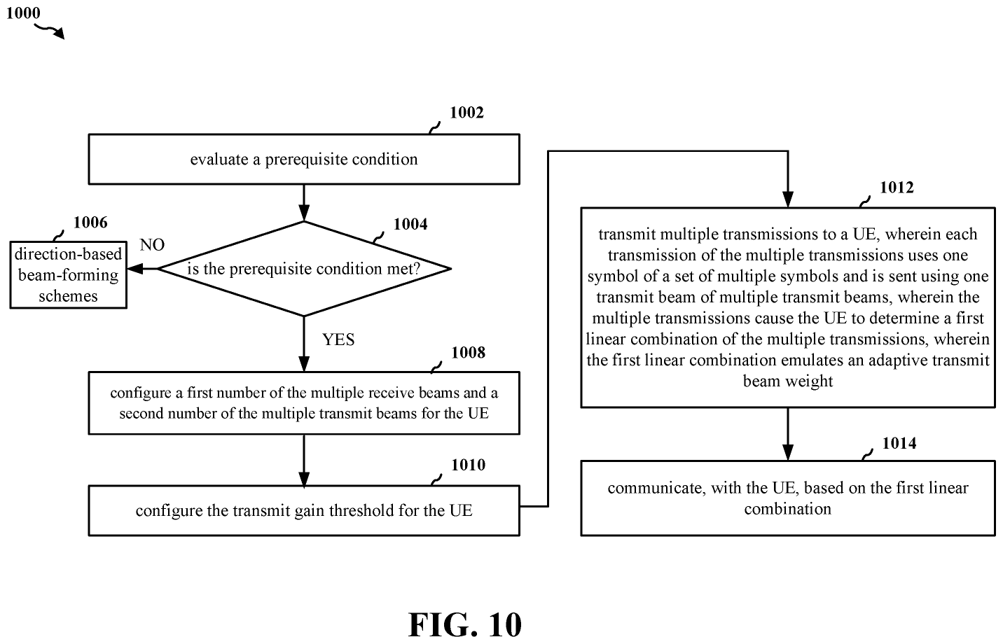

FIG. 10 is a flowchart 1000 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 604; or the network entity 1102 in the hardware implementation of FIG. 11). The method enables a UE to emulate the adaptive transmitting weight based on a linear combination of multiple transmissions, and to adjust the receive beams based on the linear combination. The method improves signal reception and efficiency of wireless communication.

As shown in FIG. 10, at 1012, the network entity may transmit multiple transmissions to a UE. Each transmission of the multiple transmissions uses one symbol of a set of multiple symbols and may be sent using one transmit beam of multiple transmit beams. The multiple transmissions may cause the UE to determine a first linear combination of the multiple transmissions. The first linear combination may emulate an adaptive transmit beam weight of the network entity. The UE may be the UE 104, 350, 602, or the apparatus 1104 in the hardware implementation of FIG. 11. FIG. 6 illustrates various aspects of the steps in connection with flowchart 1000. For example, referring to FIG. 6, the network entity (base station 604) may transmit, at 620, multiple transmissions to a UE 602. Each transmission of the multiple transmissions may use one symbol of a set of multiple symbols and may be sent using one transmit beam of multiple transmit beams {fᵢ_{₁}, . . . , fᵢ_{_{K}}}. The multiple transmissions may cause the UE to determine a first linear combination of the multiple transmissions (at 622), and the first linear combination may emulate an adaptive transmit beam weight of the network entity (base station 604).

At 1014, the network entity may communicate with the UE based on the first linear combination. For example, referring to FIG. 5, at 508, the UE may generate the adjusted receive beam weight g corresponding to effective network side adaptive beam weight, which is based on the first linear combination of the multiple transmissions. At 510, the network entity may communicate with the UE based on the adjusted receive beam weight g.

In some aspects, the multiple transmissions may be received by the UE using an adaptive receive beam weight, and the adaptive receive beam weight may be determined based on a second linear combination of multiple receive beams of the UE. For example, referring to FIG. 5, at 504, the UE may generate an adaptive beam weight g_{dyn}, and the multiple transmissions may be received by the UE using the adaptive receive beam weight gain according to Equation (7). The adaptive receive beam weight (g_{dyn}) may be generated based on a second linear combination of multiple receive beams {gᵢ_{₁}, . . . , gᵢ_{_{K}}} according to Equation (6).

In some aspects, the first linear combination may be determined by the UE based on the SNR associated with the multiple transmissions. For example, the first linear combination of the multiple transmissions may be determined to maximize the SNR, according to Equation (8).

In some aspects, the first linear combination may correspond to an amplitude and phase setting for weighting the multiple transmissions. For example, according to Equation (8), δₖ and ϵₖ that maximize the SNR may correspond to an amplitude (δₖ) and phase (ϵₖ) setting for weighting the multiple transmissions {fᵢ_{₁}, . . . , fᵢ_{_{K}}}.

In some aspects, the multiple transmit beams may be directionally steerable, and the adaptive transmit beam weight may approximate a dominant right-singular vector of the channel between the network entity and the UE with a linear combination of the multiple transmit beams with gains above a transmit gain threshold. For example, the multiple transmit beams {fᵢ_{₁}, . . . , fᵢ_{_{K}}} may be directionally steerable, and the adaptive transmit beam weight may approximate a dominant right-singular vector of the channel between the network entity and the UE with a linear combination of the multiple transmit beams {fᵢ_{₁}, . . . , fᵢ_{_{K}}} with gains above a transmit gain threshold.

In some aspects, the multiple transmit beams may be selected by the network entity from a network-side beamforming codebook. For example, the multiple transmit beams {fᵢ_{₁}, . . . , fᵢ_{_{K}}} may be selected by the network entity from a network-side beamforming codebook.

At 1010, the network entity may configure the transmit gain threshold for the UE. For example, referring to FIG. 6, the network entity (base station 604) may configure, at 614, the transmit gain threshold for the UE 602.

At 1002, the network entity may, prior to being configured to transmit the multiple transmissions, evaluate a prerequisite condition. In some aspects, the network entity may transmit the multiple transmissions in response to the prerequisite condition is determined (at 1004) to be met. In some aspects, the network entity may use other beamforming schemes, such as a direction-based beam forming scheme (at 1006) if the prerequisite condition is not met. For example, referring to FIG. 6, the network entity (base station 604) may, prior to being configured to transmit the multiple transmissions (at 620), evaluate a prerequisite condition at 608.

In some aspects, the prerequisite condition may be based on one or more of: the number of dominant clusters in a channel between the network entity and the UE, the angular spread associated with each of the dominant clusters, the transmitting antenna array dimension at the network entity, the receiving antenna array dimension at the UE, the mobility condition between the network entity and the UE, and the rate requirement between the network entity and the UE. For example, referring to FIG. 6, when the network entity (base station 604) evaluates a prerequisite condition at 608, the prerequisite condition may be based on one or more of the number of dominant clusters in the channel between the network entity (base station 604) and the UE 602, the angular spread associated with each of the dominant clusters, the transmitting antenna array dimension at the network entity (base station 604), the receiving antenna array dimension at the UE 602, the mobility condition between the network entity (base station 604) and the UE 602, and the rate requirement between the network entity (base station 604) and the UE 602.

In some aspects, the multiple receive beams and the multiple transmit beams may be selected based on a beam training process. For example, referring to FIG. 5, at 502, the multiple receive beams {gᵢ_{₁}, . . . , gᵢ_{_{K}}} and the multiple transmit beams {fᵢ_{₁}, . . . , fᵢ_{_{K}}} may be selected based on a beam training process.

At 1008, the network entity may configure a first number of the multiple receive beams and a second number of the multiple transmit beams for the UE based on the channel condition of a channel between the network entity and the UE. For example, referring to FIG. 6, the network entity (base station 604) may configure, at 610, a configuration of a first number of the multiple receive beams and a second number of the multiple transmit beams for the UE 602 based on the channel condition of the channel between the network entity (base station 604) and the UE 602.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see UE 350 of FIG. 3) and include the additional modules of the apparatus 1104.

As discussed supra, the component 198 may be configured to receive multiple transmissions from a network entity, where each transmission of the multiple transmissions uses one symbol of a set of multiple symbols and is sent using one transmit beam of multiple transmit beams; and determine a first linear combination of the multiple transmissions, where the first linear combination emulates an adaptive transmit beam weight for the network entity. The component 198 may be further configured to perform any of the aspects described in connection with the flowcharts in FIG. 7 and FIG. 8, and/or performed by the UE 602 in FIG. 6. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for receiving multiple transmissions from a network entity, where each transmission of the multiple transmissions uses one symbol of a set of multiple symbols and is sent using one transmit beam of multiple transmit beams, and means for determining a first linear combination of the multiple transmissions, where the first linear combination emulates an adaptive transmit beam weight for the network entity. The apparatus 1104 may further include means for performing any of the aspects described in connection with the flowcharts in FIG. 7 and FIG. 8, and/or aspects performed by the UE 602 in FIG. 6. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

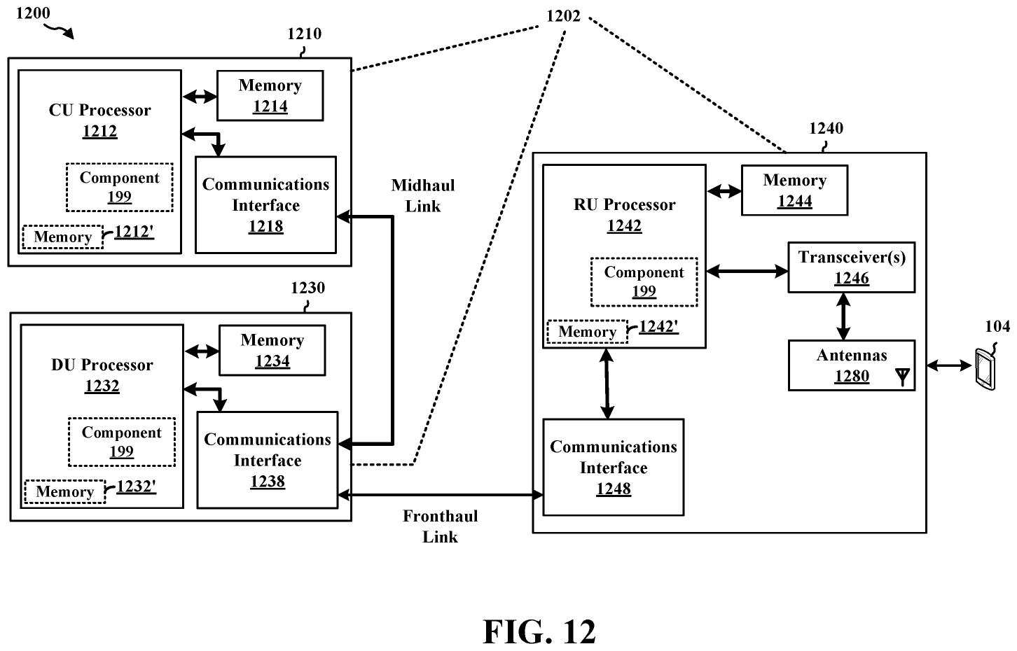

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit multiple transmissions to a UE, where each transmission of the multiple transmissions uses one symbol of a set of multiple symbols and is sent using one transmit beam of multiple transmit beams, the multiple transmissions cause the UE to determine a first linear combination of the multiple transmissions, and where the first linear combination emulates an adaptive transmit beam weight for the network entity; and communicate with the UE based on the first linear combination of the multiple transmissions. The component 199 may be further configured to perform any of the aspects described in connection with the flowcharts in FIG. 9 and FIG. 10, and/or performed by the base station 604 in FIG. 6. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 includes means for transmitting multiple transmissions to a UE, where each transmission of the multiple transmissions uses one symbol of a set of multiple symbols and is sent using one transmit beam of multiple transmit beams, the multiple transmissions cause the UE to determine a first linear combination of the multiple transmissions, and where the first linear combination emulates an adaptive transmit beam weight for the network entity, and means for communicating with the UE based on the first linear combination of the multiple transmissions. The network entity 1202 may further include means for performing any of the aspects described in connection with the flowcharts in FIG. 9 and FIG. 10, and/or aspects performed by the base station 604 in FIG. 6. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving multiple transmissions from a network entity, where each transmission of the multiple transmissions uses one symbol of a set of multiple symbols and is sent using one transmit beam of multiple transmit beams; and determining a first linear combination of the multiple transmissions, where the first linear combination emulates an adaptive transmit beam weight for the network entity. The method enables a UE to emulate the adaptive transmitting weight based on a linear combination of multiple transmissions of independent symbols, and to adjust the receive beams based on the linear combination. The method improves signal reception and efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method may include receiving multiple transmissions from a network entity, where each transmission of the multiple transmissions uses one symbol of a set of multiple symbols and is sent using one transmit beam of multiple transmit beams; and determining a first linear combination of the multiple transmissions. The first linear combination may emulate an adaptive transmit beam weight of the network entity.

Aspect 2 is the method of aspect 1, where the multiple transmissions may be received by the UE using an adaptive receive beam weight of the UE, and the method may further include: determining the adaptive receive beam weight based on a second linear combination of multiple receive beams.

Aspect 3 is the method of any of aspects 1 to 2, where the first linear combination may be determined based on the SNR associated with the multiple transmissions.

Aspect 4 is the method of any of aspects 1 to 3, where the first linear combination may correspond to an amplitude and phase setting for weighting the multiple transmissions.

Aspect 5 is the method of any of aspects 1 to 3, where the multiple transmit beams may be directionally steerable. The adaptive transmit beam weight may approximate a dominant right-singular vector of a channel between the network entity and the UE with a linear combination of the multiple transmit beams with gains above a transmit gain threshold.

Aspect 6 is the method of aspect 5, where the multiple transmit beams may be selected by the network entity from a network-side beamforming codebook.

Aspect 7 is the method of aspect 5, where the method may further include receiving the transmit gain threshold in a configuration from the network entity, or determining the transmit gain threshold at the UE.

Aspect 8 is the method of any of aspects 1 to 7, where the method may further include adjusting the adaptive receive beam weight according to the first linear combination to obtain the adjusted receive beam weight.

Aspect 9 is the method of aspect 8, where the multiple receive beams may be directionally steerable, and the adjusted adaptive receive beam weight may approximate a dominant left-singular vector of a channel between the network entity and the UE with a linear combination of the multiple receive beams.

Aspect 10 is the method of aspect 9, where the multiple receive beams may be selected by the UE from a UE-side beamforming codebook.

Aspect 11 is the method of any of aspects 1 to 10, where the method may further include, prior to determining the first linear combination, evaluating a prerequisite condition, and the first linear combination is determined in response to the prerequisite condition being met.

Aspect 12 is the method of aspect 11, where the prerequisite condition may be based on one or more of: the number of dominant clusters in a channel between the network entity and the UE, the angular spread associated with each of the dominant clusters, the transmitting antenna array dimension at the network entity, the receiving antenna array dimension at the UE, the mobility condition between the network entity and the UE, and the rate requirement between the network entity and the UE.

Aspect 13 is the method of any of aspects 2 to 12, where the multiple receive beams and the multiple transmit beams may be selected based on a beam training process.

Aspect 14 is the method of aspect 13, where the method may further include receiving, from the network entity, a configuration of a first number of the multiple receive beams and a second number of the multiple transmit beams based on a channel condition of a channel between the network entity and the UE, or determining, at the UE, the first number of the multiple receive beams and the second number of the multiple transmit beams based on the channel condition of the channel between the network entity and the UE.

Aspect 15 is an apparatus for wireless communication at a UE, including: a memory; and at least one processor coupled to the memory and, based at least in part on information stored in the memory, the at least one processor is configured to perform the method of any of aspects 1-14.

Aspect 16 is the apparatus of aspect 15, further including at least one of a transceiver or an antenna coupled to the at least one processor and configured to receive the multiple transmissions from the network entity.

Aspect 17 is an apparatus for wireless communication including means for implementing the method of any of aspects 1-14.

Aspect 18 is a computer-readable medium (e.g., a non-transitory computer-readable medium) storing computer executable code, where the code when executed by a processor causes the processor to implement the method of any of aspects 1-14.

Aspect 19 is a method of wireless communication at a network entity. The method may include transmitting multiple transmissions to a UE, where each transmission of the multiple transmissions uses one symbol of a set of multiple symbols and is sent using one transmit beam of multiple transmit beams, and the multiple transmissions cause the UE to determine a first linear combination of the multiple transmissions, where the first linear combination of the multiple transmissions emulates an adaptive transmit beam weight of the network entity; and communicating with the UE based on the first linear combination of the multiple transmissions.

Aspect 20 is the method of aspect 19, where the multiple transmissions may be received by the UE using an adaptive receive beam weight, and the adaptive receive beam weight may be determined based on a second linear combination of multiple receive beams of the UE.

Aspect 21 is the method of any of aspects 19 to 20, where the first linear combination may be determined by the UE based on the SNR associated with the multiple transmissions.

Aspect 22 is the method of any of aspects 19 to 21, where the first linear combination may correspond to an amplitude and phase setting for weighting the multiple transmissions.

Aspect 23 is the method of any of aspects 19 to 21, where the multiple transmit beams may be directionally steerable, and the adaptive transmit beam weight may approximate a dominant right-singular vector of a channel between the network entity and the UE with a linear combination of the multiple transmit beams with gains above a transmit gain threshold.

Aspect 24 is the method of aspect 23, where the multiple transmit beams may be selected by the network entity from a network-side beamforming codebook.

Aspect 25 is the method of aspect 23, where the method may further include configuring the transmit gain threshold for the UE.

Aspect 26 is the method of any of aspects 19 to 25, where the method may further include, prior to transmitting the multiple transmissions, evaluating a prerequisite condition, and the multiple transmissions are transmitted in response to the prerequisite condition being met.

Aspect 27 is the method of aspect 26, where the prerequisite condition may be based on one or more of: the number of dominant clusters in a channel between the network entity and the UE, the angular spread associated with each of the dominant clusters, the transmitting antenna array dimension at the network entity, the receiving antenna array dimension at the UE, the mobility condition between the network entity and the UE, and the rate requirement between the network entity and the UE.

Aspect 28 is the method of any of aspects 20 to 27, where the multiple receive beams and the multiple transmit beams may be selected based on a beam training process.

Aspect 29 is the method of aspect 28, where the method may further include configuring the first number of the multiple receive beams and the second number of the multiple transmit beams for the UE based on the channel condition of the channel between the network entity and the UE.

Aspect 30 is an apparatus for wireless communication at a network entity, including: a memory; and at least one processor coupled to the memory and, based at least in part on information stored in the memory, the at least one processor is configured to perform the method of any of aspects 19-29.

Aspect 31 is the apparatus of aspect 30, further including at least one of a transceiver or an antenna coupled to the at least one processor and configured to transmit the multiple transmissions to the UE.

Aspect 32 is an apparatus for wireless communication including means for implementing the method of any of aspects 19-29.

Aspect 33 is a computer-readable medium (e.g., a non-transitory computer-readable medium) storing computer executable code, where the code when executed by a processor causes the processor to implement the method of any of aspects 19-29.

What is claimed is:

1. An apparatus for wireless communication at a user equipment (UE), comprising:
memory; and
at least one processor coupled to the memory and, based at least in part on information stored in the memory, the at least one processor is configured to:
receive multiple transmissions from a network entity, wherein each transmission of the multiple transmissions uses one symbol of a set of multiple symbols and is sent using one transmit beam of multiple transmit beams; and
determine a first linear combination of the multiple transmissions, wherein the first linear combination emulates an adaptive transmit beam weight for the network entity.

2. The apparatus of claim 1, further comprising a transceiver coupled to the at least one processor, wherein, to receive the multiple transmissions, the at least one processor is configured to receive the multiple transmissions via the transceiver, and
wherein the multiple transmissions are received by the UE using an adaptive receive beam weight of the UE, and wherein the at least one processor is further configured to:
determine the adaptive receive beam weight based on a second linear combination of multiple receive beams.

3. The apparatus of claim 2, wherein the first linear combination is determined based on a signal-to-noise ratio (SNR) associated with the multiple transmissions.

4. The apparatus of claim 2, wherein the first linear combination corresponds to an amplitude and phase setting for weighting the multiple transmissions.

5. The apparatus of claim 2, wherein the multiple transmit beams are directionally steerable, and the adaptive transmit beam weight approximates a dominant right-singular vector of a channel between the network entity and the UE with a linear combination of the multiple transmit beams with gains above a transmit gain threshold, wherein the transmit gain threshold determines an approximation error.

6. The apparatus of claim 5, wherein the multiple transmit beams are selected by the network entity from a network-side beamforming codebook.

7. The apparatus of claim 5, wherein the at least one processor is further configured to:
receive the transmit gain threshold in a configuration from the network entity, or
determine the transmit gain threshold at the UE.

8. The apparatus of claim 2, wherein the at least one processor is further configured to:
adjust the adaptive receive beam weight according to the first linear combination to obtain adjusted receive beam weight.

9. The apparatus of claim 8, wherein the multiple receive beams are directionally steerable, and the adjusted adaptive receive beam weight approximates a dominant left-singular vector of a channel between the network entity and the UE with a linear combination of the multiple receive beams.

10. The apparatus of claim 9, wherein the multiple receive beams are selected by the UE from a UE-side beamforming codebook.

11. The apparatus of claim 1, wherein the at least one processor is further configured to:
prior to being configured to determine the first linear combination, evaluate a prerequisite condition, and wherein, to determine the first linear combination, the at least one processor is configured to:
determine the first linear combination in response to the prerequisite condition being met.

12. The apparatus of claim 11, wherein the prerequisite condition is based on one or more of:
a number of dominant clusters in a channel between the network entity and the UE,
an angular spread associated with each of the dominant clusters,
a transmitting antenna array dimension at the network entity,
a receiving antenna array dimension at the UE,
a mobility condition between the network entity and the UE, and
a rate requirement between the network entity and the UE.

13. The apparatus of claim 2, wherein the multiple receive beams and the multiple transmit beams are selected based on a beam training process.

14. The apparatus of claim 13, wherein the at least one processor is further configured to:
receive, from the network entity, a configuration of a first number of the multiple receive beams and a second number of the multiple transmit beams based on a channel condition of a channel between the network entity and the UE, or
determine, at the UE, the first number of the multiple receive beams and the second number of the multiple transmit beams at the UE based on the channel condition of the channel between the network entity and the UE.

15. An apparatus for wireless communication at a network entity, comprising:
memory; and
at least one processor coupled to the memory and, based at least in part on information stored in the memory, the at least one processor is configured to:
transmit multiple transmissions to a user equipment (UE), wherein each transmission of the multiple transmissions uses one symbol of a set of multiple symbols and is sent using one transmit beam of multiple transmit beams, the multiple transmissions cause the UE to determine a first linear combination of the multiple transmissions, and wherein the first linear combination emulates an adaptive transmit beam weight for the network entity; and
communicate with the UE based on the first linear combination of the multiple transmissions.

16. The apparatus of claim 15, further comprising a transceiver coupled to the at least one processor, wherein, to transmit the multiple transmissions, the at least one processor is configured to transmit the multiple transmissions via the transceiver, and
wherein the multiple transmissions are received by the UE using an adaptive receive beam weight, and the adaptive receive beam weight is determined based on a second linear combination of multiple receive beams of the UE.

17. The apparatus of claim 16, wherein the first linear combination is determined by the UE based on a signal-to-noise ratio (SNR) associated with the multiple transmissions.

18. The apparatus of claim 16, wherein the first linear combination corresponds to an amplitude and phase setting for weighting the multiple transmissions.

19. The apparatus of claim 16, wherein the multiple transmit beams are directionally steerable, and the adaptive transmit beam weight approximates a dominant right-singular vector of a channel between the network entity and the UE with a linear combination of the multiple transmit beams with gains above a transmit gain threshold, wherein the transmit gain threshold determines an approximation error.

20. The apparatus of claim 19, wherein the multiple transmit beams are selected by the network entity from a network-side beamforming codebook.

21. The apparatus of claim 19, wherein the at least one processor is further configured to:
configure the transmit gain threshold for the UE.

22. The apparatus of claim 15, wherein the at least one processor is further configured to:
prior to being configured to transmit the multiple transmissions, evaluate a prerequisite condition, and wherein, to transmit the multiple transmissions, the at least one processor is configured to transmit the multiple transmissions in response to the prerequisite condition being met.

23. The apparatus of claim 22, wherein the prerequisite condition is based on one or more of:
a number of dominant clusters in a channel between the network entity and the UE,
an angular spread associated with each of the dominant clusters,
a transmitting antenna array dimension at the network entity,
a receiving antenna array dimension at the UE,
a mobility condition between the network entity and the UE, and
a rate requirement between the network entity and the UE.

24. The apparatus of claim 16, wherein the multiple receive beams and the multiple transmit beams are selected based on a beam training process.

25. The apparatus of claim 24, wherein the at least one processor is further configured to:
configure a first number of the multiple receive beams and a second number of the multiple transmit beams at the UE based on a channel condition of a channel between the network entity and the UE.

26. A method of wireless communication at a user equipment (UE), comprising:
receiving multiple transmissions from a network entity, wherein each transmission of the multiple transmissions uses one symbol of a set of multiple symbols and is sent using one transmit beam of multiple transmit beams; and
determining a first linear combination of the multiple transmissions, wherein the first linear combination emulates an adaptive transmit beam weight of the network entity.

27. The method of claim 26, wherein the multiple transmissions are received by the UE using an adaptive receive beam weight of the UE, and wherein the method further comprises:
determining the adaptive receive beam weight based on a second linear combination of multiple receive beams.

28. The method of claim 27, wherein the first linear combination is determined based on a signal-to-noise ratio (SNR) associated with the multiple transmissions.

29. A method of wireless communication at a network entity, comprising:
transmitting multiple transmissions to a user equipment (UE), wherein each transmission of the multiple transmissions uses one symbol of a set of multiple symbols and is sent using one transmit beam of multiple transmit beams, wherein
the multiple transmissions cause the UE to determine a first linear combination of the multiple transmissions, wherein the first linear combination emulates an adaptive transmit beam weight of the network entity.

30. The method of claim 29, wherein the multiple transmissions are received by the UE using an adaptive receive beam weight, and the adaptive receive beam weight is determined based on a second linear combination of multiple receive beams of the UE.
